(19) United States
(12) Patent Application Publication
(10) Pub. No.: US 2010/0171375 A1
(43) Pub. Date: Jul. 8, 2010

(54) Protected Magnetic Displacement Device

(76) Inventors: Chih-Mao SHIAO, Taichung Industrial Park (TW); Ming-Chih Huang, Taichung Industrial Park (TW)

Correspondence Address: Dr. BANGER SHIA;Patent Office of Bang Shia, 102 Lindencrest Ct., Sugar Land, TX, 77479-5201, US

(21) Appl. No.: 12/350,959

(22) Filed: Jan. 8, 2009

(51) Int. Cl. H02K 41/03; H02K 5/10

(52) U.S. Cl. 310/12.33; 310/88

(57) ABSTRACT

A protected magnetic displacement device comprises a mover, a stator, a first protecting sheet and a second protecting sheet. The mover is provided with a magnetically sensitive portion, and the stator is provided with two loading portions each having plural magnets. The two loading portions are oppositely located to form a space therebetween for insertion of the magnetically sensitive portion of the mover. The first protecting sheet is located on one of the loading portions, and the second protecting sheet is located on the other of the loading portions. The magnetically sensitive portion of the mover is isolated inside the space of the stator by the first protecting sheet and the second shied cover, so that the surrounding metal objects can be prevented from being attracted into the stator since the leakage of the electromagnetic interference is avoided, thus making the mover move along the stator stably.

### BACKGROUND OF THE INVENTION

1. Field of the Invention

The present invention relates to a magnetic displacement device; and more particularly to a protected magnetic displacement device.

2. Description of the Prior Art

Referring to FIG. 1, a conventional magnetic displacement device 90 comprises a mover 91 and a stator 92. The mover 91 includes a magnetically sensitive protrusion 911, and the stator 92 includes a magnetically sensitive concave 921. The magnetically protrusion 911 of the mover 91 penetrates the magnetically sensitive concave 921 of the stator 92, so that the mover 91 will magnetically interact with the stator 92 to cause electromagnetic interference, which will leak outside from a clearance between the mover 91 and the stator 92 to magnetically attract the surrounding metal objects. Therefore, when the clearance between the mover 91 and the stator 92 is full of the metal objects, the magnetic displacement device 90 will be unable to move stably. Once the metal objects cannot be cleared out in time, the magnetic displacement device 90 is likely to be damaged.

The present invention has arisen to mitigate and/or obviate the afore-described disadvantages.

### SUMMARY OF THE INVENTION

The primary objective of the present invention is to provide a protected magnetic displacement device, which can isolate the electromagnetic interference caused by the magnetic interaction.

In order to achieve the above objective, a protected magnetic displacement device in accordance with the present invention comprises a mover, a stator, a first protecting sheet, and a second protecting sheet.

The mover is provided with a support portion and a magnetically sensitive portion disposed at one side of the support portion.

The stator includes a space for movement of the magnetically sensitive portion of the mover, and the space is provided with plural magnets for magnetically interacting with the magnetically sensitive portion of the mover.

One side of the first protecting sheet is located at one side of the stator.

One side of the second protecting sheet is located at the other side of the stator. The first protecting sheet and the second protecting sheet abut against each other to isolate the magnetically sensitive portion inside the space of the stator.

The support portion of the mover is provided with a first guide assembly and a second guide assembly adjacent to both ends of the magnetically sensitive portion. The first protecting sheet and the second protecting sheet are made to cooperate with each other in a rolling manner by the first and second guide assemblies.

### BRIEF DESCRIPTION OF THE DRAWINGS

FIG. 1 is a perspective view of a conventional magnetic displacement device;

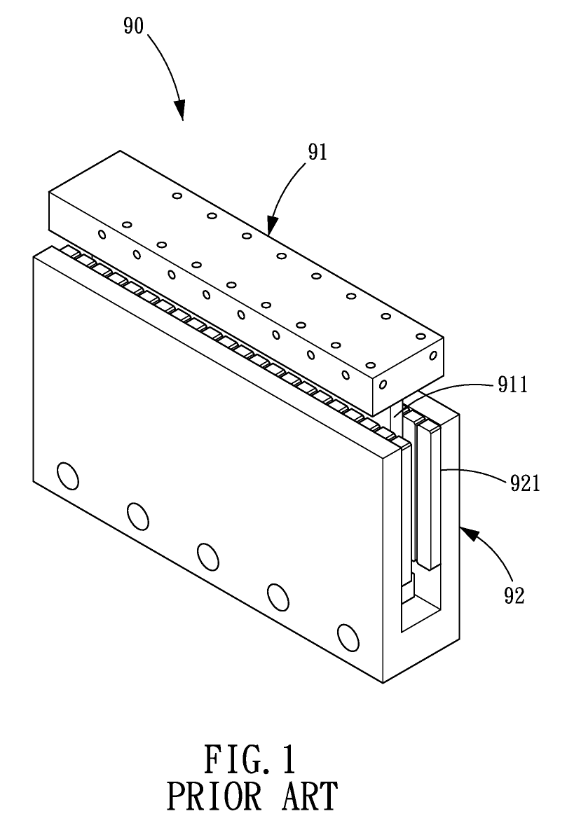

FIG. 2 is a perspective view of a magnetic displacement device in accordance with the present invention;

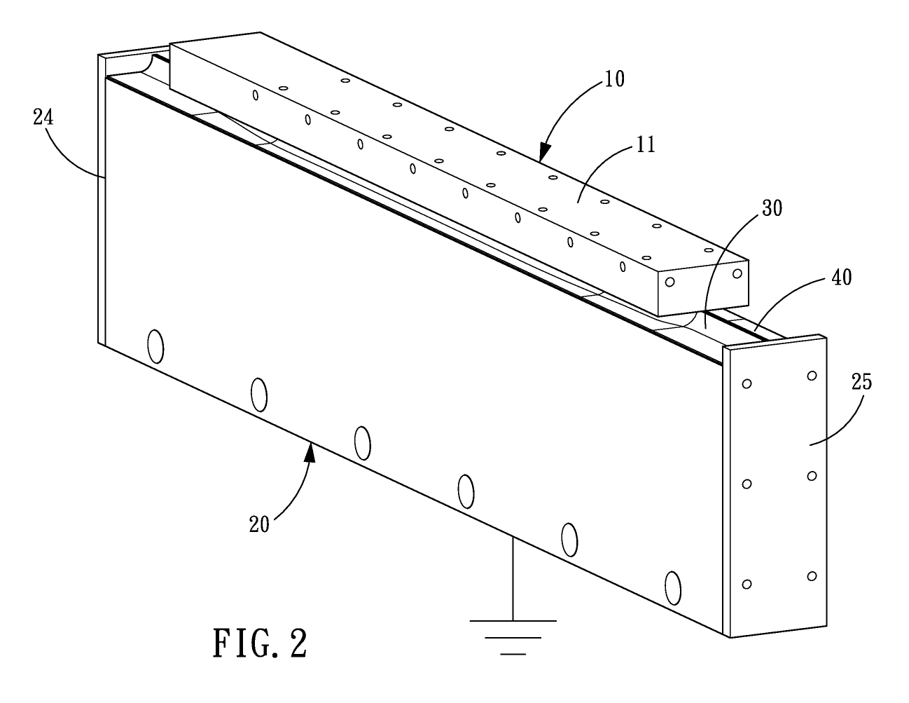

FIG. 3 is a partial exploded view of the magnetic displacement device of FIG. 2 in accordance with the present invention;

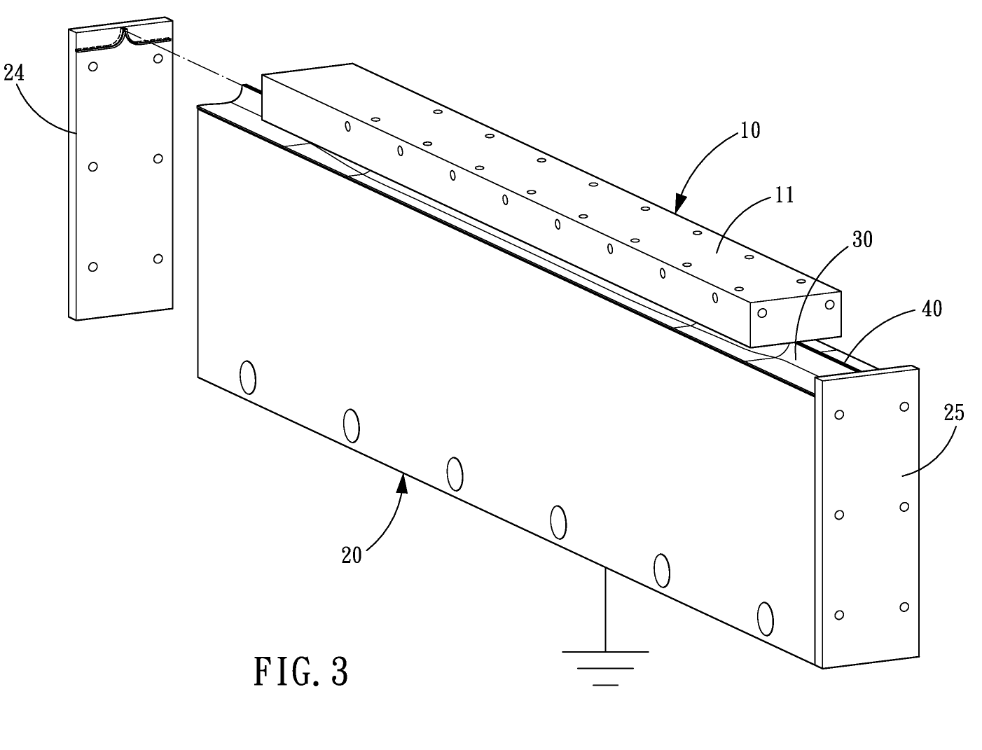

FIG. 4 is a first assembly view of the magnetic displacement device in accordance with the present invention; and

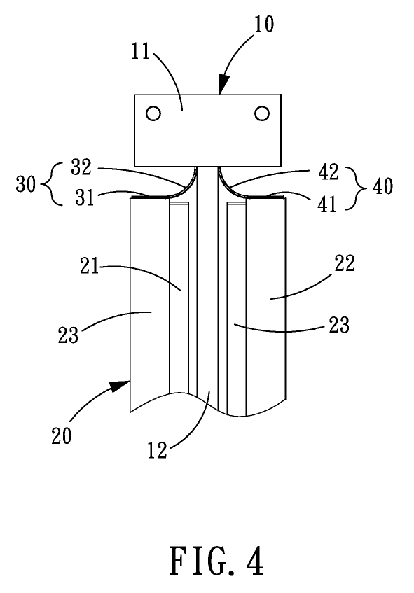

FIG. 5 is a second assembly view of the magnetic displacement device in accordance with the present invention.

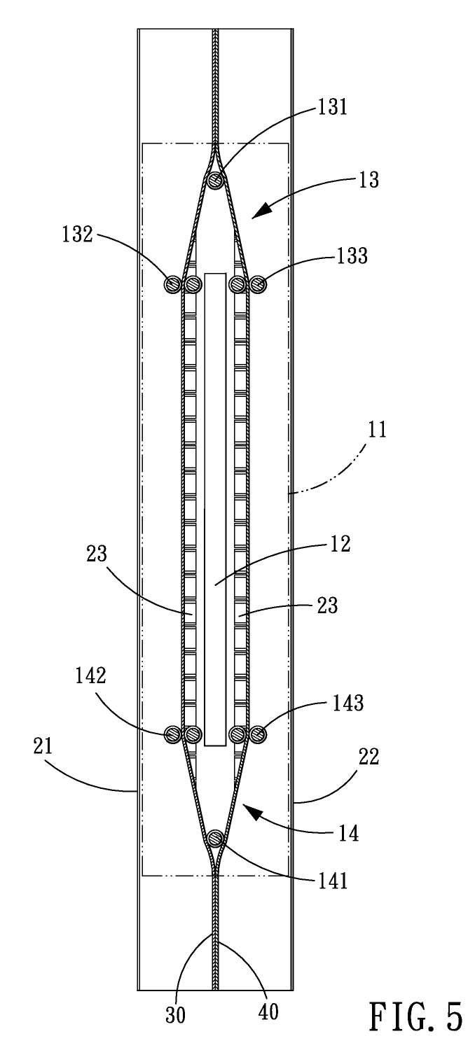

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

A magnetic displacement device in accordance with the present invention comprises a mover 10, a stator 20, a first protecting sheet 30 and a second protecting sheet 40.

The mover 10 includes a support portion 11, a magnetically sensitive portion 12, a first guide assembly 13 and a second guide assembly 14.

The mover 10 is drivingly connected to a power source through the support portion 11 in such a manner that the mover 10 can move synchronously with the power source.

The magnetically sensitive portion 12 is disposed on the bottom side of the support portion 11.

The first guide assembly 13 is disposed at one end of the bottom side of the support portion 11 and includes a front guide pulley 131, two first side pulleys 132 and two second side pulleys 133. The front guide pulley 131 is pivoted to the support portion 11 and located at one end of the magnetically sensitive portion 12 to cooperate with the first protecting sheet 30 and the second protecting sheet 40 in a rolling manner. The two first side guide pulleys 132 are pivoted to the support portion 11 and located at one side of the magnetically sensitive portion 12. Between the two first side pulleys 132 is defined a clearance in such a manner that the two first side pulleys 132 can cooperate with the first protecting sheet 30 in a rolling manner. The two second side guide pulleys 133 are pivoted to the support portion 11 and located at the other side of the magnetically sensitive portion 12. Between the two second side pulleys 133 is defined a clearance in such a manner that the two second side pulleys 133 can cooperate with the second protecting sheet 40 in a rolling manner.

The second guide assembly 14 is disposed at the other end of the bottom side of the support portion 11 and provided with a front guide pulley 141, two first side guide pulleys 142 and two second side guide pulleys 143 that are located opposite the first front guide pulley 131, the two first side guide pulleys 132 and the two second side guide pulleys 133 of the first guide assembly 13. The second guide assembly 14 is disposed symmetrically to the first guide assembly 13.

The stator 20 is provided with a first loading portion 21, a second loading portion 22, plural magnets 23, a first positioning plate 24 and a second positioning plate 25.

The first loading portion 21 and the second loading portion 22 are oppositely located on the stator 20, and between the first loading portion 21 and the second loading portion 22 is defined a space 26.

The magnets 23 are successively disposed on one side of the first loading portion 21 and one side of the second loading portion 22.

The first positioning plate 24 is disposed at one end of the stator 20, and the second positioning plate 25 is disposed at the other end of the stator 20. The first positioning plate 24 and the second positioning plate 25 seal both two axial opposite ends of the space 26, so that the space 26 is only open upward for insertion of the magnetically sensitive portion 12 of the mover 10 to make the magnetically sensitive portion 12 of the mover 10 magnetically interact with the magnets 23 of the stator 20.

The first protecting sheet 30 is provided with a fixing portion 31 and a movable portion 32. The second protecting sheet 40 is provided with a fixing portion 41 and a movable portion 42. The fixing portion 31 of the first protecting sheet 30 is locked on the top surface of the first loading portion 21 of the stator 20, and both ends of the first protecting sheet 30 are fixedly inserted into the first positioning plate 24 and the second positioning plate 25. The fixing portion 41 of the second protecting sheet 40 is locked on the top surface of the second loading portion 22 of the stator 20, and both ends of the second protecting sheet 40 are fixedly inserted into the first positioning plate 24 and the second positioning plate 25.

The movable portion 32 of the first protecting sheet 30 and the movable portion 42 of the second protecting sheet 40 oppositely abut against each other. A part of the movable portion 32 of the first protecting sheet 30 and a part of the movable portion 42 of the second protecting sheet 40 are separated from each other under the guiding of the front guide pulley 131, the first side guide pulleys 132 and the second side guide pulleys 133 of the first guide assembly 13 and will be closed with respect to each other under the guiding of the front guide pulley 141, the first side guide pulleys 142 and the second side guide pulleys 143 of the second guide assembly 14. The edge of the movable portion 32 of the first protecting sheet 30 partially abuts against the bottom side of the support portion 11 of the mover 10, and the edge of the movable portion 42 of the second protecting sheet 40 partially abuts against the bottom side of the support portion 11 of the mover 10, so that the electromagnetic interference caused by the magnetic interaction of the mover 10 and the stator 20 will be isolated inside the stator by the first protecting sheet 30 and the second protecting sheet 40.

While we have shown and described various embodiments in accordance with the present invention, it is clear to those skilled in the art that further embodiments may be made without departing from the scope of the present invention.

What is claimed is:

1. A protected magnetic displacement device comprising:
a mover being provided with a support portion and a magnetically sensitive portion disposed at one side of the support portion;
a stator being provided with a first loading portion having plural magnets, a second loading portion having plural magnets, and two positioning plates, the first loading portion and the second loading portion being oppositely disposed to form a space therebetween, the two positioning plates being disposed at both ends of the stator to seal both ends of the space between the loading portion and the second loading portion, the space being open toward one side for insertion of the magnetically sensitive portion of the mover to magnetically interact with the magnets of first loading portion and the second loading portion;
a first protecting sheet, one side of the first protecting sheet being positioned on the first loading portion of the stator, and two ends of the first protecting sheet being positioned on the two positioning plates of the stator; and
a second protecting sheet, one side of the second protecting sheet being positioned on the second loading portion of the stator, and two ends of the first protecting sheet being positioned on the two positioning plates of the stator, the other side of the first protecting sheet abutting against the other side of the second protecting sheet, so that the magnetically sensitive portion of the mover is isolated inside the space by the first protecting sheet and the second protecting sheet.

2. The protected magnetic displacement device as claimed in claim 1, wherein the support portion of the mover is provided with a first guide assembly and a second guide assembly adjacent to both ends of the magnetically sensitive portion, the first protecting sheet and the second protecting sheet are guided to be separated from each other in a rolling manner by the first guide assembly and closed with respect to each other in a rolling manner by the second guide assembly.

3. The protected magnetic displacement device as claimed in claim 2, wherein:
the first guide assembly is provided with a front guide pulley, two first side guide pulleys and two second side guide pulleys, the front guide pulley is pivoted to the support portion and located at one end of the magnetically sensitive portion to cooperate with the first protecting sheet and the second protecting sheet in a rolling manner, the two first side guide pulleys are pivoted to the support portion and located at one side of the magnetically sensitive portion, between the two first side pulleys is defined a clearance in such a manner that the two first side pulleys cooperate with the first protecting sheet in a rolling manner, the two second side guide pulleys are pivoted to the support portion and located at the other side of the magnetically sensitive portion, and between the two second side pulleys is defined a clearance in such a manner that the two second side pulleys cooperate with the second protecting sheet in a rolling manner; and
the second guide assembly is provided with a front guide pulley, two first side guide pulleys and two second side guide pulleys, the front guide pulley of the second guide assembly is pivoted to the support portion and located at the other end of the magnetically sensitive portion to cooperate with the first protecting sheet and the second protecting sheet in a rolling manner, the two first side guide pulleys of the second guide assembly are pivoted to the support portion and located at one side of the magnetically sensitive portion, between the two first side pulleys of the second guide assembly is defined a clearance in such a manner that the two first side pulleys of the second guide assembly cooperate with the first protecting sheet in a rolling manner, the two second side guide pulleys of the second guide assembly are pivoted to the support portion and located at the other side of the magnetically sensitive portion, and between the two second side pulleys of the second guide assembly is defined a clearance in such a manner that the two second side pulleys of the second guide assembly cooperate with the second protecting sheet in a rolling manner.

4. The protected magnetic displacement device as claimed in claim 2, wherein:
the first guide assembly is provided with a front guide pulley, the front guide pulley of the first guide assembly is pivoted to the support portion and located at one end of the magnetically sensitive portion to cooperate with the first protecting sheet and the second protecting sheet in a rolling manner; and
the second guide assembly is provided with a front guide pulley, the front guide pulley of the second guide assembly is pivoted to the support portion and located at the other end of the magnetically sensitive portion to cooperate with the first protecting sheet and the second protecting sheet in a rolling manner;

5. The protected magnetic displacement device as claimed in claim 4, wherein:
the first guide assembly is further provided with two first side guide pulleys and two second side guide pulleys, the two first side guide pulleys of the first guide assembly are pivoted to the support portion and located at one side of the magnetically sensitive portion, between the two first side pulleys of the first guide assembly is defined a clearance in such a manner that the two first side pulleys of the first guide assembly cooperate with the first protecting sheet in a rolling manner, the two second side guide pulleys of the first guide assembly are pivoted to the support portion and located at the other side of the magnetically sensitive portion, and between the two second side pulleys is defined a clearance in such a manner that the two second side pulleys of the first guide assembly cooperate with the second protecting sheet in a rolling manner; and
the second guide assembly is further provided with two first side guide pulleys and two second side guide pulleys, the two first side guide pulleys of the second guide assembly are pivoted to the support portion and located at one side of the magnetically sensitive portion, between the two first side pulleys of the second guide assembly is defined a clearance in such a manner that the two first side pulleys of the second guide assembly cooperate with the first protecting sheet in a rolling manner, the two second side guide pulleys of the second guide assembly are pivoted to the support portion and located at the other side of the magnetically sensitive portion, and between the two second side pulleys of the second guide assembly is defined a clearance in such a manner that the two second side pulleys of the second guide assembly cooperate with the second protecting sheet in a rolling manner.
